(19) United States
(12) Patent Application Publication
(10) Pub. No.: US 2016/0165449 A1
(43) Pub. Date: Jun. 9, 2016

(54) NOTIFICATION OF UNAUTHORIZED WIRELESS NETWORK DEVICES

(71) Applicant: Intel Corporation, Santa Clara, CA (US)

(72) Inventor: David I. Poisner, Carmichael, CA (US)

(21) Appl. No.: 14/559,592

(22) Filed: Dec. 3, 2014

(51) Int. Cl. H04W 12/08; H04L 29/06; H04W 64/00

(52) U.S. Cl. CPC H04W 12/08; H04W 64/003; H04L 63/10

(57) ABSTRACT

Apparatuses, methods, and computer-readable media relating to an unauthorized wireless network device notification system (“WNS”) are described. The WNS may be configured to notify the presence of an authorized wireless network device. (“WND”) The WNS may include an unauthorized network device identification service (“UNIS”) as well as one or more detect/notify devices (“DNDs”). The DNDs may be placed in multiple locations around a monitored space and may be configured to detect wireless network signals from a WND in their vicinity. The DNDs may then send information identifying the WND to the UNIS to determine whether the WND is authorized. If the UNIS determines that the WND is unauthorized, it may determine a location for the WND and send commands to the DNDs to notify persons in the area. This notification may include use of lighting or sound. Other embodiments may be described and/or claimed.

### TECHNICAL FIELD

The present disclosure relates to the field of data processing, in particular, to apparatuses, methods and storage media associated with providing notification of unauthorized wireless network devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Many publicly accessible places, including airports, office buildings, hospitals, etc, offer wireless networking for use by the general public. Oftentimes, these wireless networks are advertised openly to computing devices that scan for available networks, using inviting names such as “Free Public WiFi” or “Airport Internet”. These open networks are ubiquitous to the degree that members of the public have come to expect to see them in many public institutions.

However, some persons may rely on these assumptions (and the general trust of the public) toward nefarious ends. In some scenarios, a person may set up a device to advertise a wireless network that appears to offer wireless networking for the general public (e.g. “Open Public WiFi! Connect here!”). Members of the public may then see these advertised networks, and, thinking they are a legitimate service of the venue, connect to the device of the nefarious person. In some scenarios, the nefarious person may even offer Internet connectivity through their device so that members of the public that connect think they are connecting to a legitimate, trustable, public service. However, because the member of the public has connected to a device under the control of the nefarious person, the nefarious person may then be able to gain some degree of control of the computing devices of the members of the public, to surreptitiously install software on the computing devices, or to obtain sensitive information from the computing devices. This is a serious cause for security concerns, both for members of the public and for owners of venues, as these owners may wish to ensure that those who use computing devices at their venues can do safely and without fear.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for an unauthorized wireless network device notification system, in accordance with various embodiments.

FIG. 2 illustrates an example pattern used for light and sound-based notification of an unauthorized wireless network device, in accordance with various embodiments.

FIG. 3 illustrates an example process for notification of unauthorized wireless network devices, in accordance with various embodiments.

FIG. 4 illustrates an example process for setting up the unauthorized wireless network device notification system, in accordance with various embodiments.

FIG. 5 illustrates an example process for determining if a wireless device is authorized, in accordance with various embodiments.

FIG. 6 illustrates an example process for notifying the presence of an authorized wireless network device, in accordance with various embodiments.

FIG. 7 illustrates an example computing environment suitable for practicing various aspects of the present disclosure in accordance with various embodiments.

FIG. 8 illustrates an example storage medium with instructions configured to enable an apparatus to practice various aspects of the present disclosure in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. As described herein, the term “logic” and “module” may refer to, be part of, or include a System on a Chip, as described below.

In various embodiments, an unauthorized wireless network device notification system (“WNS”) may be configured to notify owners or agents of a monitored space, such as a public venue, of the presence of an authorized wireless network device. In various embodiments, the WNS may include an unauthorized network device identification service (“UNIS”) as well as one or more detect/notify devices (“DNDs”). The DNDs may be placed in multiple locations around the monitored space, and may include attached lighting which may be utilized to provide traditional lighting in the space. Thus, the DNDs may be easily an unobtrusively placed throughout a monitored space while providing useful lighting (or other environmental effects) until such a time as they are needed for notification of unauthorized wireless networks.

In various embodiments, the DNDs may be configured to detect wireless network signals from a wireless network device (“WND”) in their vicinity. The DNDs may then send information identifying the WND to the UNIS to determine whether the WND is authorized to broadcast a network in the monitored space. The UNIS may make such a determination based on information about the wireless network signals received by the DNDs, such as, for example, signal strength, MAC address, SSID of the wireless network, wireless traffic patterns, etc. The UNIS may also utilize information about authorized WNDs, such as a whitelist of allowed WNDs, and/or information about unauthorized WNDs, such as a blacklist of unauthorized WNDs.

In various embodiments, if the UNIS determines that the WND is unauthorized, it may determine a location for the WND, such as based on a triangulation of the signal strengths reported by multiple DNDs. The UNIS may then send commands to the DNDs to notify persons in the area of the presence of the unauthorized WND. In various embodiments, this notification may include use of lighting (either in a visible band or in a band visible using specialized hardware) or through the use of sound. In various embodiments, the use of directional colors, focused beams, and/or sounds may be utilized to more particularly point out the location of the unauthorized WND. Using these notifications, an owner of the monitored space, or their agent or employee, may be able to travel to the location of the unauthorized WND to deactivate it or to remove a nefarious person from the monitored space.

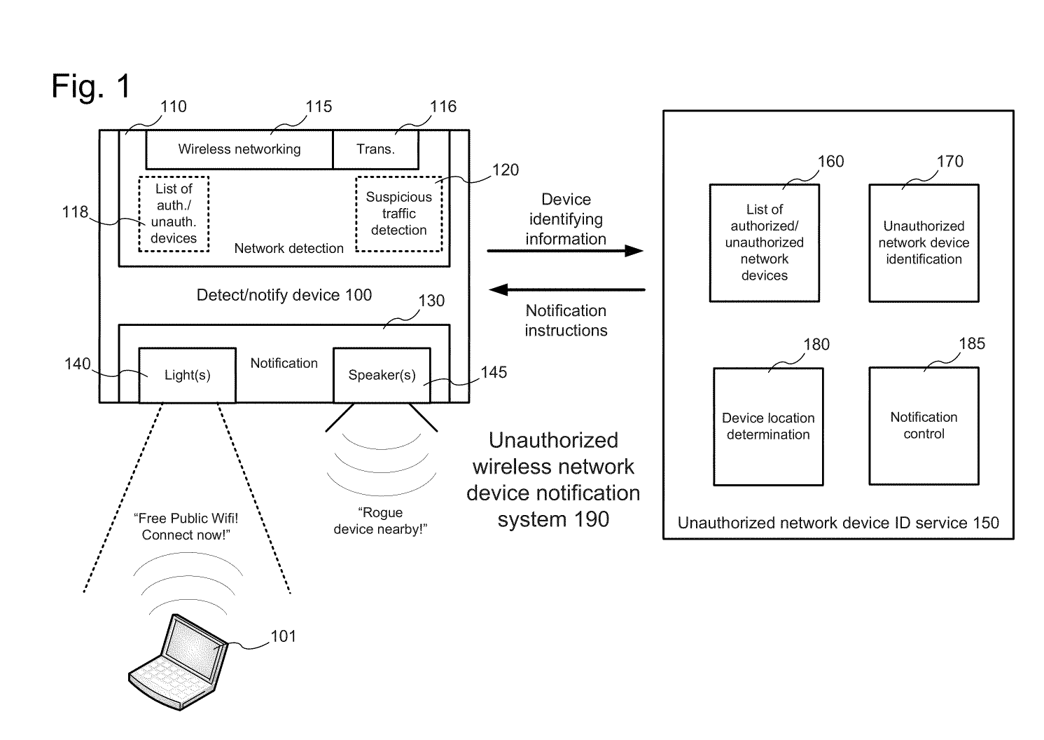

Referring now to FIG. 1, an example arrangement for an unauthorized wireless network device notification system is illustrated in accordance with various embodiments. As discussed above, in various embodiments, an unauthorized wireless network device notification system 100 (“WNS 190”) may include an unauthorized identification network device identification service 150 (“UNIS 150”) and one or more detect/notify devices 100 (“DND(s) 100”). As discussed above, in various embodiments, the WNS 190 may utilize the one or more DND(s) 100 to receive information about wireless network devices (“WNDs”) in a monitored space, and to provide identifying information about the WNDs. The UNIS 150 may, based on the received device identifying information determine whether any of the WNDs are unauthorized. If so, the UNIS 150 may send notification instructions to one or more of the DND(s) 100 to notify nearby persons of the presence of the unauthorized WNDs. Examples of embodiments of the WNS 190, UNIS 150, and one or more DND(s) 100 follow.

Examples of embodiments of DND(s) 100 are described below. While a single DND 100 is described, for purposes of clearer explanation, it may be understood that the WNS 190 may include one or more DNDs. Further, in various embodiments, various DNDs may be differently configured and may include or omit various elements described herein.

Prior to discussing particular examples of the detecting and notifying techniques described herein, it may be noted that, in various embodiments, the DND 100 may perform various functions in addition to the detecting and notifying. In particular, the DND 100 may be configured as a lighting or sound fixture of a monitored space. As illustrated, the DND 100 may include one or more light(s) 140 and/or speaker(s) 145. In various embodiments, the light(s) 140 and/or speaker(s) 145 may be utilized for traditional or environmental, lighting or sound uses in the monitored space, such as background lighting and/or background music. In other embodiments, the light(s) 140 and/or speaker(s) 145 may be utilized in an ad hoc fashion, such as, for example, when spotlights are needed or in an audio paging system. In various embodiments, the light(s) 140 and/or speaker(s) 145 may also be used by a notification module 130 of the DND 100; notification techniques are described in greater detail below.

Because the DND 100 may be utilized for various traditional lighting and environmental uses in a monitored space, in various embodiments, multiple DND(s) 100 may be installed in a distributed fashion around a monitored space. In various embodiments, one or more the DND(s) 100 may be arranged in a grid or other repeating pattern or may be arranged in a more random arrangement. In various embodiments, the DNDs may include other configurations, such as security cameras or decorative elements that may blend into the look of the monitored space. In various embodiments the monitored space itself (not illustrated) may include various open or closed spaces for which an owner or administrator may wish to provide security for persons using the space. Examples of such a monitored space may include, but are not limited to: airports, hospitals, malls, office buildings, parks, restaurants, bars, libraries, etc. In various embodiments, the WNS 100 may be implemented in a monitored space for an entire institution (such as a public library) or for just a portion of an institution (such as the lobby of an office building that is otherwise secured).

In various embodiments, the DND 100 may include a network detection module 110 (“ND 110”), which may be configured to detect wireless network signals from one or more WNDs, such as unauthorized WNDs 100, and to provide identifying information for those WNDs to the UNIS 150. In various embodiments, the ND 110 may include a wireless networking module 115 which may be configured with one or more wireless networking transceivers (not illustrated) to receive and transmit wireless signals from WNDs. In various embodiments, the wireless network module may be configured to detect wireless network signals from WND via a variety of wireless networking protocols, including, but not limited to, IEEE standards in the 802.11 family (e.g., 802.11a/b/g/n/ac) and/or Bluetooth™. In various embodiments, a WND that the wireless network module may be configured to receive wireless network signals from may include various computing devices configured to transmit wireless network signals, including laptop computers (e.g. the illustrated unauthorized WND 101), mobile devices, desktop computers, routers, etc. In the example of FIG. 1, the ND 110 is detecting signal called “Free Public WiFi! Connect Now!” from an unauthorized WND 101.

In various embodiments, the ND 110 may, in response to receipt of wireless network signals from a WND, may send identifying information for that WND to the UNIS 150. In various embodiments, such identifying information may include an identifier for an advertised wireless network of the WND, such as an SSID for the wireless network. In various embodiments, the identifying information may include unique identifiers of the WND or of wireless hardware or software used by the WND, such as, for example, a MAC address, a UUID, etc. In various embodiments, he identifying information may also include one or more frequency bands and or protocols (e.g. 802.11a/b/g/n/ac) of signals received from a WND or a number of antennas used by a WND. In various embodiments, the ND 110 may also send signal strength or signal fidelity information for the received signals to the UNIS 150. Such information may be utilized for triangulation/location of the WND, as described below. In various embodiments, the ND 110 may send identifying information using the wireless networking module 115; however in other embodiments, other wireless and/or wired techniques may be used for communication between the DND 100 and the UNIS 150, as may be understood.

In various embodiments, the ND 110 may also include additional optional modules which may facilitate the ND 110 in providing identifying information about WNDs to the UNIS 150. In particular, the ND 110 may include a list of authorized and/or unauthorized network devices 118 (“list 118”) and/or a suspicious traffic detection module 120. In various embodiments, however, the ND 110 may not include a list 118 or suspicious traffic detection module 120. In some such embodiments, the ND 110 may send identifying information on every (or substantially ever) WND for which it receives signals, and may report substantially the same information for each WND.

In various embodiments the list 118 may identify authorized and/or unauthorized network devices based on identifying information, such as, but not limited to, the information described above. The ND 110 may, in various embodiments utilize the information contained in the list 118 to identify known unauthorized WNDs such that the ND 110 may report the known unauthorized WNDs to the UNIS 150. In various embodiments, the ND 110 may utilize the information contained in the list to identify known authorized WNDs as well. In such embodiments, the ND 110 may not report identifying information for known authorized WNDs to the UNIS 150, thereby improving efficiency of communications between the DND 100 and the UNIS 150. In various embodiments, this list may be provided by the UNIS 150 based on its own list of authorized and/or unauthorized network devices 160, aspects of which are described below.

In various embodiments, the suspicious traffic detection module 120 may observe received signals from a WND and determine whether traffic associated with that WND appears suspicious. In such embodiments, the ND 110 may include indicia of the suspicious traffic in the identifying information for the WND that is sent to the UNIS 150. Particular embodiments of suspicious traffic detection may be understood by those of ordinary skill in the art and are not described further herein.

In various embodiments, the DND 100 may also include a notification module 130 (“NM 130”). In various embodiments, the NM 130 may be configured to receive notification instructions from the UNIS 150 and to control visual or auditory notifications of an unauthorized WND (such as unauthorized WND 101). In various embodiments, the NM 130 (or the DND 100) may include the aforementioned light(s) 140 and speaker(s) 145. However in other embodiments, the DND 100 may not include the light(s) 140 or the speaker(s) 145. In such embodiments, light(s) 140 and/or speaker(s) 145 may be provided outside of the DND 100, and may be controlled by the NM 130 of the DND 100 through a direct or remote coupling.

In various embodiments, the NM 130 may be configured to control illumination of the light(s) 140 to notify nearby persons of the presence of the unauthorized WND. In various embodiments, the light(s) 140 may be configured to be controlled in various ways, including, but not limited to: strength of illumination, strobe rate, strobe pattern, light color, etc. In various embodiments, the light(s) 140 may be configured to illuminate in various light spectra, including visible and/or non-visible light. In embodiments where the light(s) 140 are configured to illuminate using non-visible light, the light(s) 140 may be configured to illuminate an area such that the illumination may be picked up using special equipment (e.g. night-vision goggles to be used with infrared illumination), as may be understood. In various embodiments, the light(s) 140 may also be configured to provide a focused beam of light, such that an unauthorized WND 101 may be directly pointed at by illumination from the light(s) 140.

In various embodiments, the NM 130 may be configured to control the speaker(s) 145 to produce auditory notifications to notify nearby persons of the presence of the unauthorized WND 101. In various embodiments, these auditory notifications may include various types of auditory notifications and sounds, including, but not limited to: alarms, tones, pre-recorded spoken messages (such as the message illustrated in FIG. 1), synthesized speech, etc. In various embodiments, if synthesized speech is used, the NM 130 may cause the speech to include information about the unauthorized WND 101, such as, for example the SSID of the unauthorized WND 101.

Referring now to the UNIS 150, in various embodiments, the UNIS 150 may include one or more entities that may be configured to identify unauthorized WNDs as well as to control one or more DND(s) 100 to provide notification of the presence of the unauthorized WNDs. In various embodiments, the UNIS 150 may be implemented in various manners, including, but not limited to: single or multiple computing devices, computing servers, and distributed or cloud-based computing systems. In various embodiments, the UNIS 150 may be located at or near a monitored space or maybe located remotely from a monitored space. Additionally, in various embodiments, one UNIS 150 may be associated with one or more monitored spaces.

In various embodiments, the UNIS 150 may include one or more modules that may be configured to facilitate the UNIS 150 in identifying unauthorized WNDs and in controlling notification of the identified WNDs. In various embodiments, the UNIS 150 may include a list of authorized and/or unauthorized network devices 160 (“list 160”), which may identify authorized and/or unauthorized network devices based on identifying information, such as, but not limited to, the information described above. The UNIS 150 may, in various embodiments utilize the information contained in the list 118 to identify known unauthorized WNDs, such as when receiving identifying information for WNDs from the DND 100. In various embodiments, the UNIS 150 may utilize the information contained in the list to identify known authorized WNDs as well. In various embodiments, the UNIS 150 may populate the list 160 from information gained from external sources, such as externally-maintained whitelists or blacklists, and/or based on information gained from monitoring of WNDs by various DND(s) 100.

In various embodiments, the UNIS 150 may also include an unauthorized network wireless device identification module 170 (“UID 170”), which may be configured to determine, for a WND for which identifying information is received, whether the WND is authorized or unauthorized. In various embodiments, the UID 170 may make such a determination based on information from the list 160 and/or identifying information received from the DND 100 (including, when available suspicious traffic indicia). In various embodiments, the UIC 170 may also be configured to support authorization procedures with one or more WNDs, such as web-based authorization procedures. These authorization procedures may be understood by those of ordinary skill and are not discussed further herein for the sake of simpler description. Particular embodiments of actions performed by the UID 170 are described below.

In various embodiments, the UNIS 150 may also include a device location determination module 180 (“DLD 180”) which may be configured to determine a location for a WND. In various embodiments, the DLD 180 may be configured to determine such locations based on signal strength or signal fidelity information received from one or more DND(s) 100. In various embodiments, the DLD 180 may utilize known triangulation techniques for such location determination; particular implementations of location determination are thus understood, and are not discussed further herein.

In various embodiments, the UNIS 150 may also include a notification control module 185 (“NC 185”), which may be configured to control one or more DND(s) 100 to provide notification of the presence of an unauthorized WND. In various embodiments, the NC 185 may provide instructions to be followed by the NMs 130 of one or more DND(s) 100. In various embodiments, the NC 185 may determine a notification pattern for notification and may base notification instructions on that notification pattern. Particular examples of notification patterns are provided below. In addition, in some embodiments, the NC 185 may be configured to perform notifications itself to authorities and/or to personnel associated with the monitored space. For example, the NC 185 may be configured to call or email a person to alert them to the existence of the unauthorized WND 101 in the monitored space and to let them know that further notification is being performed by DND(s) 100. The notified person may thus be informed that they should travel to the location of the notification to find the unauthorized WND 101.

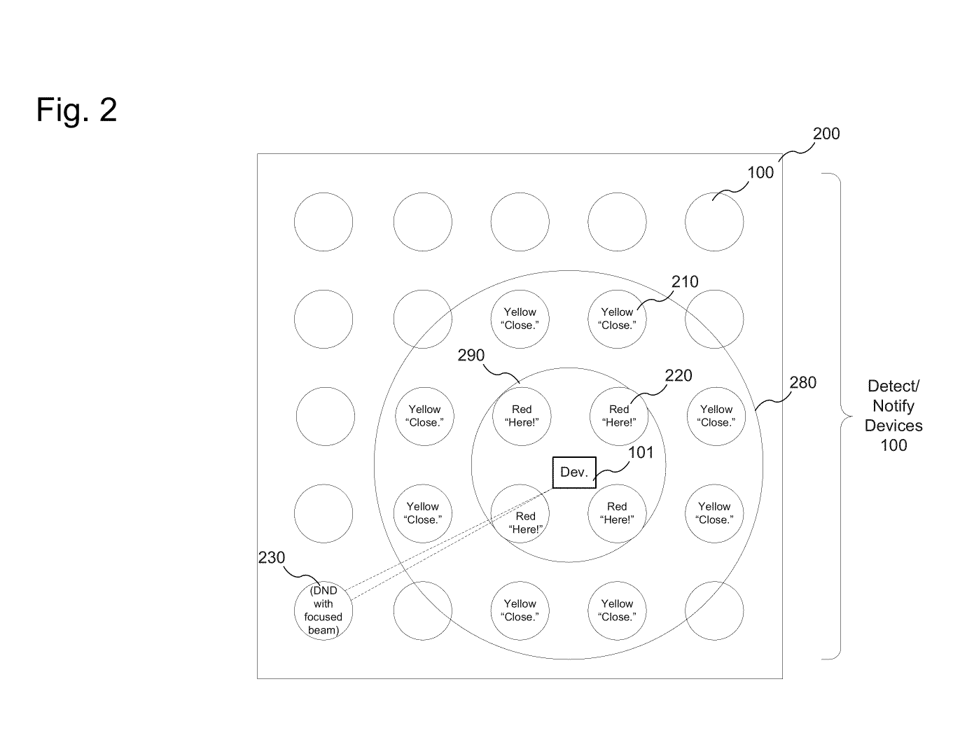

Referring now to FIG. 2, an example pattern used for light and sound-based notification of an unauthorized wireless network device is illustrated in accordance with various embodiments. In the example of FIG. 2, multiple DND(s) 100 are arranged in a grid in a monitored space 200. In the example an unauthorized WND 101 has been detected and the UNIS 150 (and more specifically the NC 185, as sent notification instructions to the DND(s) 100 to notify nearby persons of the presence of the unauthorized WND 101. In the example pattern, the UNIS 150 has identified two distances (280 and 290) from the unauthorized WND 101, and has provided different notification instructions to the DND(s) 100 based on their locations within these distances from the unauthorized WND 101. Thus, those DND(s) 100 that are within the closest identified distance 280 from the unauthorized WND 101 have been given notification instructions to illuminate a red light using light(s) 140 and to produce a “Here!” message using speaker(s) 145. Those DND(s) 100 that are within the next identified distance 290 from the unauthorized WND 101 have been given notification instructions to illuminate using a yellow light using light(s) 140 and to produce a “Close.” message using speaker(s) 145. In the example, by using multiple different illuminations and messages, a person in the vicinity of the unauthorized WND 101 may thus be able to locate and address the unauthorized WND 101 using the different colors and messages provided by the DND(s) 100. Additionally, as shown in FIG. 2, a DND 230 is configured with light(s) 140 that can produce a movable, focusable beam of light. In the example, the UNIS 150 has provided notification instructions to the particular DND 230 to focus the bean of light directly on the unauthorized WND 101. This may also aid a person in identifying and addressing the presence of the unauthorized WND 101.

While particular examples were given with respect to FIG. 2, in various embodiments, the UNIS 150/NM 185 may be configured to provide notification instructions based on other patterns. In one example, the NM 185 may control DND(s) 100 to illuminate or produce sounds in an ordered sequence leading toward the unauthorized WND 101. In another example, the NM 185 may control DND(s) 100 to increase (or decrease) a blink rate of their lights 140 based on their distance from the unauthorized WND 101. In another example, the NM 185 may instruct the DND(s) 100 to illuminate the unauthorized WND 101 using non-visible light such that a nefarious person is unaware of the notification, allowing for authorities to be contacted. Various other patterns and manners of notification may be provided by the UNIS 150 and NM 185.

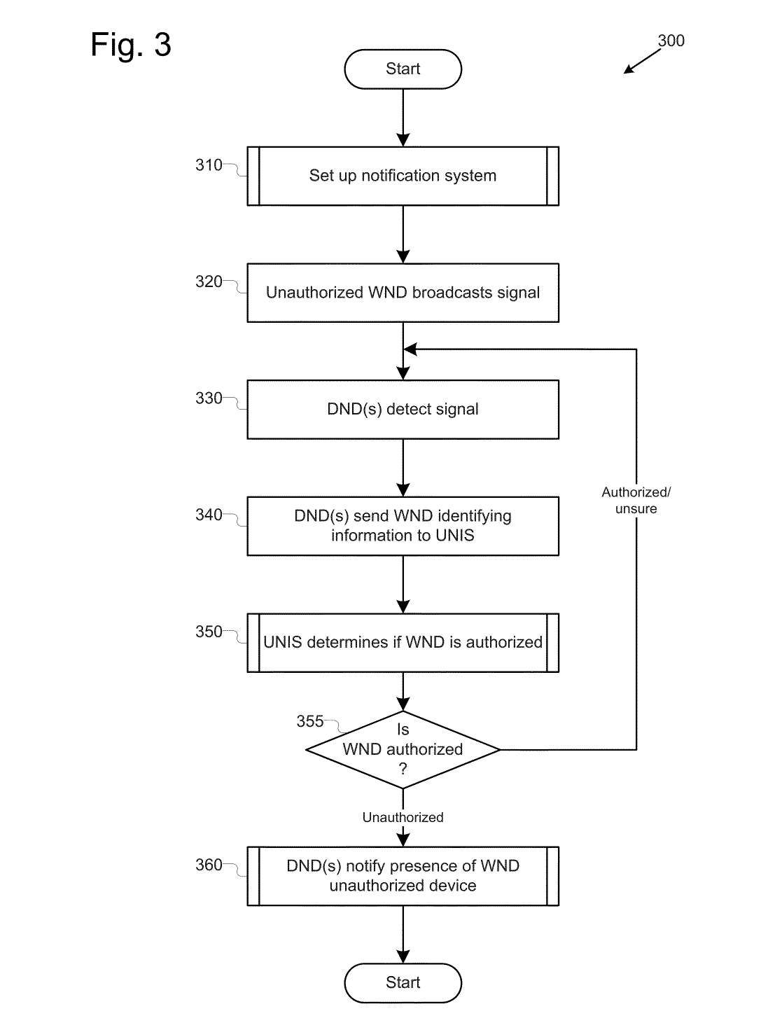

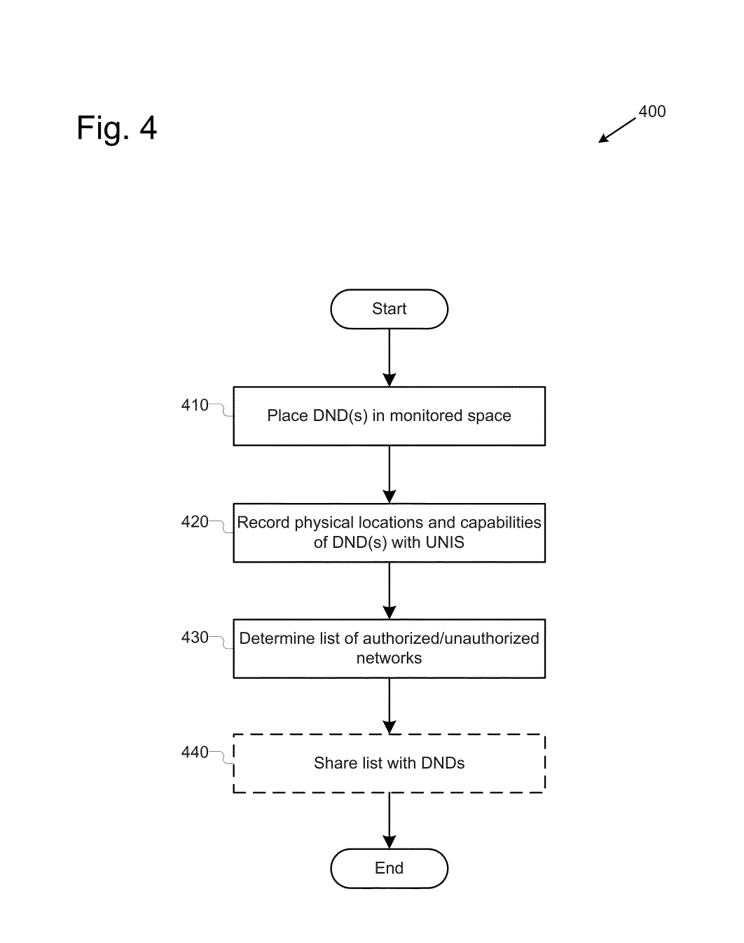

FIG. 3 illustrates an example process 300 for notification of unauthorized wireless network devices, in accordance with various embodiments. While FIG. 3 illustrates particular operations in a particular order, in various embodiments the operations may be combined, split into parts, and/or omitted. In various embodiments, operations of process 300 (as well as sub-processes) may be performed by one or more of the DND 100 and/or UNIS 150, as well as various modules of the DND 100 and/or UNIS 150. The process may begin at operation 310, wherein the WNS 190, including one or more DND(s) 100 and UNIS 150 may be set up. Particular embodiments of the process of operation 310 are described below with reference to process 400 of FIG. 4.

Next, at operation 320, a WND may broadcast a wireless network signal. In various embodiments, this wireless network signal may be configured according to various known protocols, such as described above. Next, at operation 330 one or more DND(s) 100, and in particular the ND(s) 110 of the DND(s) 100, may detect the signal broadcasted from the WND. In various embodiments, the DND(s) 100 may be configured to continually scan for new wireless networks in order to detect signals as they are first broadcast. Next, at operation 340, the DND(s) 100 may send identifying information collected from the signal to the UNIS 150. Examples of identifying information which may be sent to the UNIS 150 are described above. In various embodiments, the DND(s) 100 may also send identifying information for the DND(s) themselves at operation 340, in order that the UNIS 150 may more easily determine the location of the WND, such as based on triangulation using locations of the DND(s).

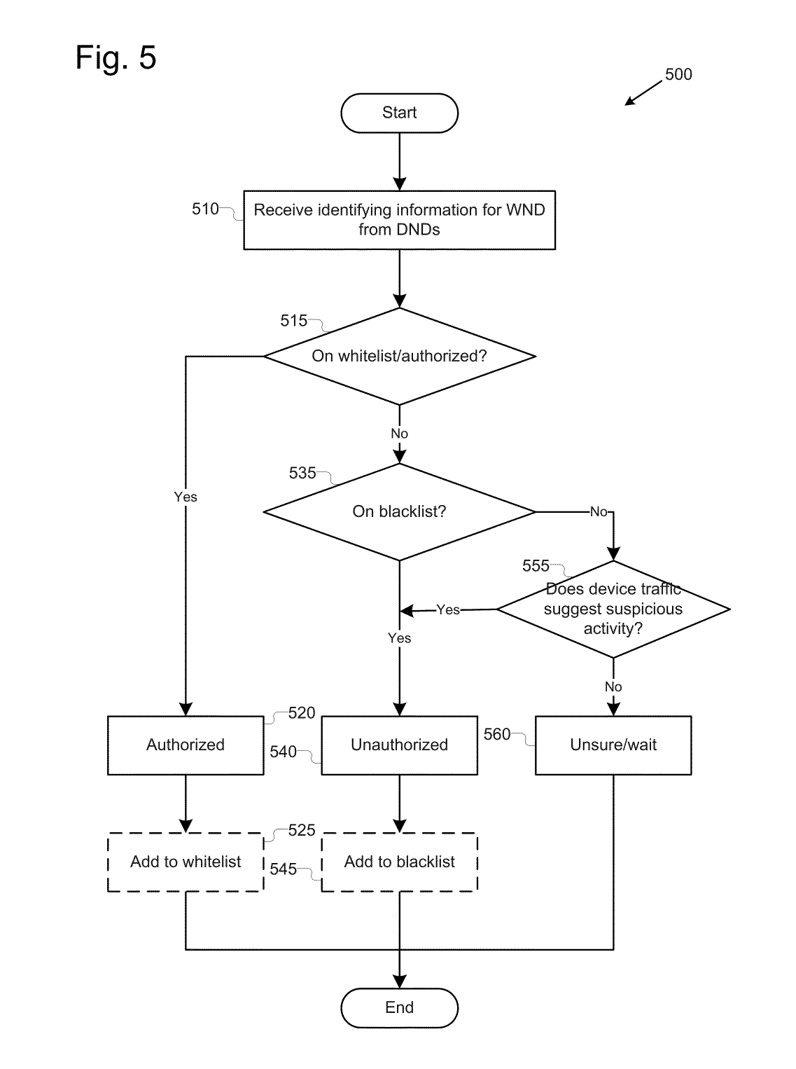

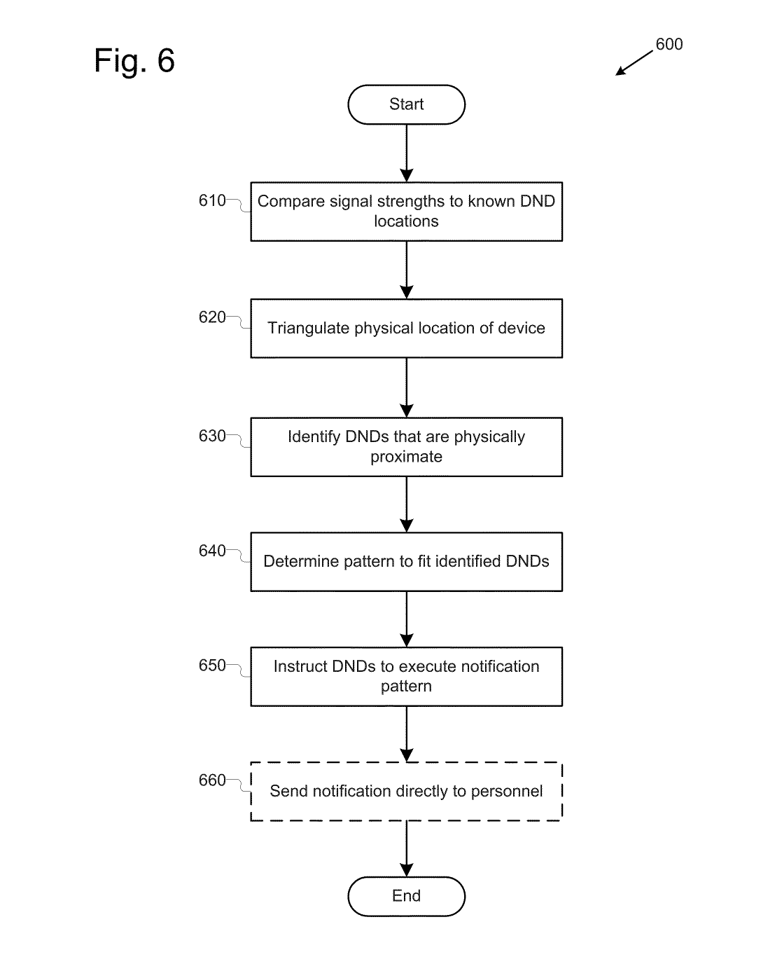

At operation 350, the UNIS 150 may determine whether the detected WND is authorized, unauthorized, or if it is not known at the current time whether the device is authorized. Thus, if the UNIS cannot currently determine whether the WND is authorized, no further action may be taken with regard to the WND until additional information is gained from one or more DND(s). Particular embodiments of the process of operation 350 are described below with reference to process 500 of FIG. 5. If, at decision operation 355, the UNIS determines that the WND is authorized or if it is unsure, then the process may return to operation 330 to detect for other WND signals. If, however, at decision 355, the UNIS 150 determines that the wireless device is unauthorized, then at operation 360, the UNIS 150 may control one or more DND(s) to notify of the presence of the unauthorized WND. Particular embodiments of the process of operation 360 are described below with reference to process 600 of FIG. 6. The process may then end.

FIG. 4 illustrates an example process 400 for setting up the unauthorized WNS 190 in accordance with various embodiments. In various embodiments, process 400 may be performed to implement, in whole or in part, operation 310 of process 300 of FIG. 3. While FIG. 4 illustrates particular operations in a particular order, in various embodiments the operations may be combined, split into parts, and/or omitted. In various embodiments, operations of process 400 (as well as sub-processes) may be performed by one or more of the DND 100 and/or UNIS 150, as well as various modules of the DND 100 and/or UNIS 150. The process may begin at operation 410, where one or more DND(s) 100 may be placed in the monitored space. As discussed above, in various embodiments, the DND(s) 100 may be placed in such an arrangement as to provide traditional lighting using their respective lights 140. In various embodiments, the DND(s) 100 may be placed such that they achieve effective detection or notification coverage and/or to provide for more efficient triangulation of possible locations of unauthorized WNDs. Next, at operation 420, the physical locations and capabilities of the DND(s) 100 may be recorded with the UNIS 150. In various embodiments, the physical locations may be recorded with the UNIS 150 in order that the DLD 180 of the UNIS 150 may triangulate locations of unauthorized WNDs. In various embodiments, the capabilities of the DND(s) 100 may be recorded with the UNIS 150 in order that the NC 185 of the UNIS 150 may determine which notification instructions to send to which DND(s) 100. In various embodiments, these capabilities may include information about the light(s) 140 and/or speaker(s) 145, such as possible colors, spectra, and/or modes of illumination of the light(s) 140, and pre-recorded messages or speech synthesis available to the speaker(s) 145.

Next, at operation 430 the UNIS 150 may determine the list 160 of authorized and/or unauthorized WNDs. In various embodiments, the list 160 may be determined based on information gained from external sources, such as security databases. In other embodiments, WNDs may be identified for inclusion on the list based on information received previously by the UNIS 150 for a current monitored space or for other monitored spaces. In yet other embodiments, WNDs may be identified for inclusion on the list based on information received previously by other UNISes 150 for other monitored spaces. Next, at operation 440, the UNIS 150 may optionally share the information from the list 160 with one or more DND(s) 100 for inclusion in their respective optional lists 118. After optional operation 440, the process may then end.

FIG. 5 illustrates an example process 500 for determining if a wireless device is authorized, in accordance with various embodiments. In various embodiments, process 500 may be performed to implement, in whole or in part, operation 350 of process 300 of FIG. 3. While FIG. 5 illustrates particular operations in a particular order, in various embodiments the operations may be combined, split into parts, and/or omitted. In various embodiments, operations of process 500 (as well as sub-processes) may be performed by the UNIS 150, and in particular by the UID 170 of the UNIS 150. The process may begin at operation 510, where the UNIS 150 may receive identifying information for the WND from the DND(s). In various embodiments, this information may also include information identifying the DND(s) themselves. Next, at decision operation 515, the UID 170 may consult the list 160 to determine if the identified WND is on a whitelist or is otherwise authorized. In various embodiments, the WND may have been separately authorized with the UID 170, such as through performance of an authorization procedure using the device. Such authorization may be understood by those of ordinary skill and is not discussed further herein. If the WND does appear on a whitelist or is otherwise authorized, then at operation 520, the UID 170 may determine that the WND is authorized. Additionally, if the WND is not currently listed on a whitelist in the list 160, then at operation 525 the WND may be added to a whitelist in the list 160. The process may then end.

If, however, the UID 170 determines at decision operation 515 that the WND is not on a whitelist or authorized, then at decision operation 535, the UID 170 may determine whether the WND is on a blacklist, such as by checking information in the list 160. If so, then at operation 540, the UID 170 may determine that the WND is unauthorized. The process may then end, in various embodiments skipping the optional “Add to blacklist” operation 545 because the WND was already determined to be on a blacklist.

If, however, the UID 170 determines at decision operation 535 that the WND is not on a blacklist, then at decision operation 555, the UID 170 may determine whether traffic associated with the WND, such as that received from one or more DND(s) 100, suggests the WND is performing suspicious activity. If so, then at operation 540, the UID 170 may determine that the WND is unauthorized. Next, in various embodiments the UID 170 may optionally add the WND to a blacklist in the list 160 at operation 545. The process may then end. If, however, the UID 170 determines at decision operation 555 that the WND is does not exhibit suspicious activity, then at operation 560, the UID 170 may determine that it is currently unsure whether the WND is authorized. The process may then end.

It may be noted that in various embodiments, as seen in process 300 of FIG. 3, process 500 of FIG. 5 may be repeated again for the same WND after more signal information is received by one or more DND(s) 100. Thus, in a later iteration of process 500, the WND may later be determined to be authorized or unauthorized based on receipt of additional information.

FIG. 6 illustrates an example process 600 for notifying the presence of an authorized wireless network device, in accordance with various embodiments. In various embodiments, process 600 may be performed to implement, in whole or in part, operation 360 of process 300 of FIG. 3. While FIG. 6 illustrates particular operations in a particular order, in various embodiments the operations may be combined, split into parts, and/or omitted. In various embodiments, operations of process 600 (as well as sub-processes) may be performed by the UNIS 150 and DND(s) 100, as well as by modules of the UNIS 150 and DND(s) 100. The process may begin at operation 610, where the DLD 180 may compare signal strengths received by one or more DND(s) 100 from an unauthorized WND to the known physical locations of those DND(s) 100. Next, at operation 620, the DLD 180 may, using these compared values, triangulate a physical location for the unauthorized WND. As discussed above, at operation 620, the DLD 180 may perform triangulation according to various known techniques, as may be understood.

Next, at operation 630, the NC 185 may determine one or more DND(s) 100 that are physically proximate to the physical location of the WND. At operation 640, the NC 185 may select a notification pattern for the DND(s) 100 to execute that fits the physical locations and capabilities of the various DNDs that are proximate to the WND. Next, at operation 650, the NC 185 may send notification instructions to the DND(s) 100 to execute the determined notification pattern. Next, at optional operation 660, the NC 185 may send a notification directly to personnel (such as an owner or facility security) that an unauthorized WND has been detected. In various embodiments, this notification may include an indication of the physical location of the unauthorized WND (either general or specific), so that the personnel may travel to the location, utilizing the notification of the various DND(s) 100 to particularly locate the unauthorized WND. The process may then end.

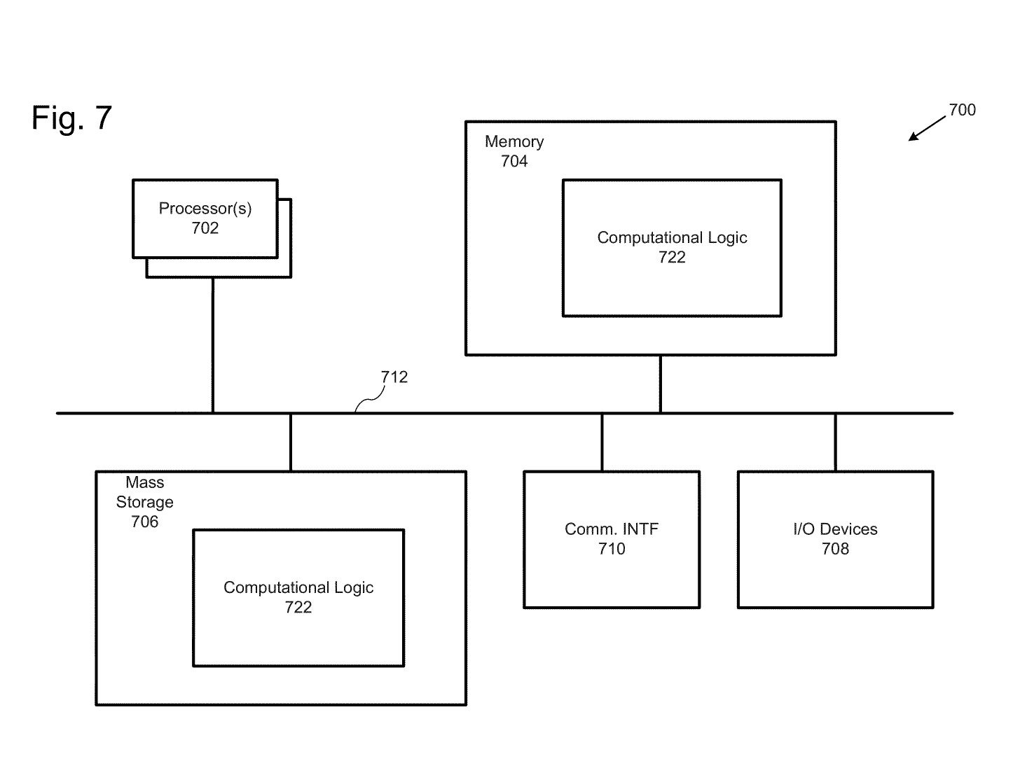

Referring now to FIG. 7, an example computer suitable for practicing various aspects of the present disclosure, including processes of FIGS. 3-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth, WiFi, Near Field Communications, Radio-frequency identification, and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing one or more of the modules shown in FIG. 1, and/or the operations associated with techniques shown in FIGS. 3-6, collectively referred to as computing logic 722. The various elements may be implemented by assembler instructions supported by processor(s) 702 or high-level languages, such as, for example, C, that can be compiled into such instructions. In various embodiments, the system memory 704 or mass storage 706 may include various memory implementations, including integrated flash memory, such as in a System on a Chip, a USB flash drive, SD Card, on SATA SSD, etc.

The permanent copy of the programming instructions may be placed into permanent storage devices 706 in the factory, or in the field, through, for example, a distribution medium (not shown), such as a compact disc (CD), or through communication interface 710 (from a distribution server (not shown)). In embodiments, the programming instructions may be stored in one or more computer readable non-transitory storage media. In other embodiments, the programming instructions may be encoded in transitory storage media, such as signals.

The number, capability and/or capacity of these elements 710-712 may vary. Their constitutions are otherwise known, and accordingly will not be further described.

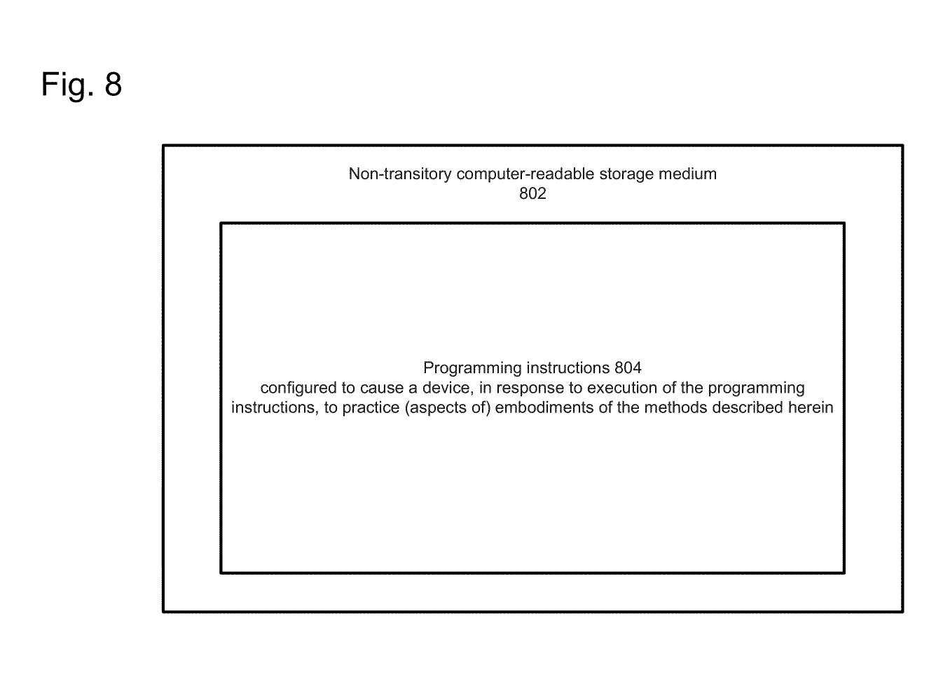

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 3-6, e.g., but not limited to, to the various operations performed to perform notification of unauthorized WNDs. In alternate embodiments, programming instructions 804 may be disposed on multiple least one computer-readable storage media 802 instead.

Referring back to FIG. 7, for one embodiment, at least one of processors 702 may be packaged together with computational logic 722 configured to practice aspects of processes of FIGS. 3-6. For one embodiment, at least one of processors 702 may be packaged together with computational logic 722 configured to practice aspects of processes of FIGS. 3-6 to form a System in Package (SiP). For one embodiment, at least one of processors 702 may be integrated on the same die with computational logic 722 configured to practice aspects of processes of FIGS. 3-6. For one embodiment, at least one of processors 702 may be packaged together with computational logic 722 configured to practice aspects of processes of FIGS. 3-6 to form a System on Chip (SoC). For at least one embodiment, the SoC may be utilized in, e.g., but not limited to, a computing tablet. (e.g., WiFi, Blue Tooth, Blue Tooth Low Energy, Near Field Communications, Radio-frequency identification (RFID), etc.) and other components as necessary to meet functional and non-functional requirements of the system.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques. Particular examples of embodiments, described herein include, but are not limited to, the following:

Example 1 may be an apparatus to identify unauthorized wireless network devices. The apparatus may include one or more wireless networking transceivers. The apparatus may also include one or more computer processors coupled to the one or more wireless networking transceivers. The apparatus may also include a network detection module to be operated by the one or more computer processors to receive signals for one or more wireless network devices via the wireless networking transceivers and, based on the received signals for the one or more wireless network devices, facilitate determination of a presence of an unauthorized wireless network device. The apparatus may also include a notification module to be operated by the one or more computer processors to issue a notification of the determination of the presence of an unauthorized wireless network device.

Example 2 may include the apparatus of example 1, wherein the unauthorized wireless network identification module may be further operated to send identifying information for the one or more wireless network devices to a remote network identification service and the unauthorized wireless network identification module is operated to facilitate determination of a presence of an unauthorized wireless network device through receipt of identification of the unauthorized wireless network device from the network identification service.

Example 3 may include the apparatus of any of the above apparatus examples, wherein the unauthorized wireless network identification module may send identifying information that includes, for a wireless network device out of the one or more wireless network devices, a signal strength for the wireless network device.

Example 4 may include the apparatus of any one of examples 2-3, wherein the unauthorized wireless network identification module may send identifying information that includes, for a wireless network device out of the one or more wireless network devices, a MAC address for the wireless network device.

Example 5 may include the apparatus of any one of examples 2-4, wherein the unauthorized wireless network identification module may send identifying information that includes, for a wireless network device out of the one or more wireless network devices, an SSID for the wireless network device.

Example 6 may include the apparatus of any one of examples 2-5, wherein the unauthorized wireless network identification module may send identifying information that includes, for a wireless network device out of the one or more wireless network devices, traffic or connection data for the wireless network device.

Example 7 may include the apparatus of any one of examples 2-6, wherein the unauthorized wireless network identification module may be further operated to compare identifying information for the one or more wireless network devices to a list including authorization information for a plurality of wireless network devices.

Example 8 may include the apparatus of any one of examples 2-7, wherein unauthorized wireless network identification module may be further operated to analyze traffic activity of the one or more wireless network devices to determine if the traffic activity is suspicious.

Example 9 may include the apparatus of any of examples 1-8, wherein the notification module may be operated to control one or more lights to issue a notification of identification of a presence of an unauthorized wireless network device through control of a color of the one or more lights.

Example 10 may include the apparatus of any of examples 1-9, wherein the notification module may be operated to control one or more lights to issue a notification of identification of a presence of an unauthorized wireless network device through control of a rate of blinking of the one or more lights.

Example 11 may include the apparatus of any of examples 1-10, wherein the notification module may be operated to control one or more lights to issue a notification of identification of a presence of an unauthorized wireless network device through control of a direction of the one or more lights.

Example 12 may include the apparatus of any of examples 1-11, wherein: the apparatus may further include one or more lights; and the notification module may be operated to control the one or more lights to issue a notification of determination of a presence of an unauthorized wireless network device.

Example 13 may include the apparatus of example 12, wherein the notification module may control one or more lights to emit a visible wavelength of light.

Example 14 may include the apparatus of example 12, wherein the notification module may control the one or more lights to emit a non-visible wavelength of light.

Example 15 may include the apparatus of any of examples 1-14, wherein the notification module may further control one or more speakers to produce audio to issue a notification of determination of a presence of the unauthorized wireless network device.

Example 16 may include the apparatus of example 15, further including the one or more speakers.

Example 17 may include an apparatus to identify unauthorized wireless network devices. The apparatus may include one or more computer processors. The apparatus may also include an unauthorized network identification module to be operated by the one or more computer processors to receive identifying information for a one or more wireless network devices and, based on the identifying information, identify an unauthorized wireless network device out of the one or more wireless network devices. The apparatus may also include a notification control module to be operated by the one or more computer processors to control one or more remote notification devices to issue a notification of the presence of the unauthorized wireless network device.

Example 18 may include the apparatus of example 17, wherein the unauthorized network identification module may be to receive identifying information from the one or more remote notification devices.

Example 19 may include the apparatus of any of examples 17 or 18, wherein: the apparatus may further include a device location module to be operated by the one or more computer processors to determine a location of the unauthorized wireless network device; and the notification control module may further control the one or more remote notification devices to issue a notification of the location of the unauthorized wireless network device.

Example 20 may include the apparatus of example 19, wherein the device location module may be to determine a location of the unauthorized wireless network device based on wireless network signal strength information received from the one or more remote notification devices.

Example 21 may include the apparatus of any of examples 17-20, wherein the notification control module may be further to: determine a notification pattern for controlling the one or more remote notification devices and control the one or more remote notification devices according to the pattern.

Example 22 may include the apparatus of example 21, wherein notification control module may be to determine a notification pattern to control different remote notification devices to illuminate one or more lights using different light colors.

Example 23 may include the apparatus of example 21, wherein notification control module may be to determine a notification pattern to control different remote notification devices to illuminate one or more lights using different light blinking rates.

Example 24 may include the apparatus of example 21, wherein notification control module may be to determine a notification pattern to control different remote notification devices to output different audio notifications.

Example 25 may include the apparatus of example 21, wherein notification control module may be to determine a notification pattern to control different remote notification devices according to their respective distances from the unauthorized wireless network device.

Example 26 may include a computer-implemented method for identifying unauthorized wireless network devices. The method may include: receiving, by a network detection module of a computing system, signals for one or more wireless network devices via one or more wireless networking transceivers; based on the received signals for the one or more wireless network devices, facilitating, by the network detection module, determination of a presence of an unauthorized wireless network device; and issuing, by a notification module of the computing system, notification of the determination of the presence of an unauthorized wireless network device.

Example 27 may include the method of example 26, wherein the method further may include sending, by the unauthorized wireless network identification module, identifying information for the one or more wireless network devices to a remote network identification service and facilitating determination of a presence of an unauthorized wireless network device includes receiving identification of the unauthorized wireless network device from the network identification service.

Example 28 may include the method of example 27, wherein sending identifying information may include sending, for a wireless network device out of the one or more wireless network devices, a signal strength for the wireless network device.

Example 29 may include the method of any one of examples 27-28, wherein sending identifying information may include sending, for a wireless network device out of the one or more wireless network devices, a MAC address for the wireless network device.

Example 30 may include the method of any one of examples 27-29, wherein sending identifying information may include sending, for a wireless network device out of the one or more wireless network devices, an SSID for the wireless network device.

Example 31 may include the method of any one of examples 27-30, wherein sending identifying information may include sending, for a wireless network device out of the one or more wireless network devices, traffic or connection data for the wireless network device.

Example 32 may include s the method of any one of examples 27-31, and may further include comparing, by the unauthorized wireless network identification module, identifying information for the one or more wireless network devices to a list including authorization information for a plurality of wireless network devices.

Example 33 may include the method of any one of examples 27-32, and may further include analyzing, by the unauthorized wireless network identification module, traffic activity of the one or more wireless network devices to determine if the traffic activity is suspicious.

Example 34 may include the method of any of examples 26-33, wherein issuing notification may include controlling one or more lights to issue a notification of identification of a presence of an unauthorized wireless network device through control of a color of the one or more lights.

Example 35 may include the method of any of examples 26-34, wherein issuing notification may include controlling one or more lights to issue a notification of identification of a presence of an unauthorized wireless network device through control of a rate of blinking of the one or more lights.

Example 36 may include the method of any of examples 26-35, wherein issuing notification may include controlling one or more lights to issue a notification of identification of a presence of an unauthorized wireless network device through control of a direction of the one or more lights.

Example 37 may include the method of any of examples 26-36, wherein the computing system may further include one or more lights; and issuing notification may include controlling the one or more lights to issue a notification of determination of a presence of an unauthorized wireless network device.

Example 38 may include the method of example 37, wherein controlling the one or more lights may include controlling the one or more lights to emit a visible wavelength of light.

Example 39 may include the method of example 37, wherein controlling the one or more lights may include controlling the one or more lights to emit a non-visible wavelength of light.

Example 40 may include the method of any of examples 26-39, wherein issuing notification may include controlling one or more speakers to produce audio to issue a notification of determination of a presence of the unauthorized wireless network device.

Example 41 may include one or more computer-readable media including instructions written thereon that, in response to execution by a computing system, cause the computing system to identify unauthorized wireless network devices. The instructions may be to cause the computing system to: receive signals for one or more wireless network devices via one or more wireless networking transceivers; based on the received signals for the one or more wireless network devices, facilitate determination of a presence of an unauthorized wireless network device; and issue notification of the determination of the presence of an unauthorized wireless network device.

Example 42 may include the computer-readable media of example 41, wherein the instructions may be further to cause the computing system to send identifying information for the one or more wireless network devices to a remote network identification service and facilitate determination of a presence of an unauthorized wireless network device includes receive identification of the unauthorized wireless network device from the network identification service.

Example 43 may include the computer-readable media of example 42, wherein send identifying information may include send, for a wireless network device out of the one or more wireless network devices, a signal strength for the wireless network device.

Example 44 may include the computer-readable media of any one of examples 42-43, wherein send identifying information may include send, for a wireless network device out of the one or more wireless network devices, a MAC address for the wireless network device.

Example 45 may include the computer-readable media of any one of examples 42-44, wherein send identifying information may include send, for a wireless network device out of the one or more wireless network devices, an SSID for the wireless network device.

Example 46 may include the computer-readable media of any one of examples 42-45, wherein send identifying information may include send, for a wireless network device out of the one or more wireless network devices, traffic or connection data for the wireless network device.

Example 47 may include the computer-readable media of any one of examples 42-46, wherein the instructions may be further to cause the computing system to compare identifying information for the one or more wireless network devices to a list including authorization information for a plurality of wireless network devices.

Example 48 may include the computer-readable media of any one of examples 42-47, wherein the instructions may be further to cause the computing system to analyze traffic activity of the one or more wireless network devices to determine if the traffic activity is suspicious.

Example 49 may include the computer-readable media of any of examples 41-48, wherein issue notification may include control one or more lights to issue a notification of identification of a presence of an unauthorized wireless network device through control of a color of the one or more lights.

Example 50 may include the computer-readable media of any of examples 41-49, wherein issue notification may include control one or more lights to issue a notification of identification of a presence of an unauthorized wireless network device through control of a rate of blinking of the one or more lights.

Example 51 may include the computer-readable media of any of examples 41-50, wherein issue notification may include control one or more lights to issue a notification of identification of a presence of an unauthorized wireless network device through control of a direction of the one or more lights.

Example 52 may include the computer-readable media of any of examples 41-48, wherein: the computing system further may include one or more lights; and issue notification may include control the one or more lights to issue a notification of determination of a presence of an unauthorized wireless network device.

Example 53 may include the computer-readable media of example 52, wherein control the one or more lights may include control the one or more lights to emit a visible wavelength of light.

Example 54 may include the computer-readable media of example 52, wherein the notification module may be to control the light to emit a non-visible wavelength of light.

Example 55 may include the computer-readable media of any of examples 41-54, wherein issue notification may include control one or more speakers to produce audio to issue a notification of determination of a presence of the unauthorized wireless network device.

Example 56 may include an apparatus for identifying unauthorized wireless network devices. The apparatus may include: means for receiving signals for one or more wireless network devices via one or more wireless networking transceivers; means for facilitating, based on the received signals for the one or more wireless network devices, determination of a presence of an unauthorized wireless network device; and means for issuing notification of the determination of the presence of an unauthorized wireless network device.

Example 57 may include the apparatus of example 56, wherein: the apparatus further may include means for sending identifying information for the one or more wireless network devices to a remote network identification service and means for facilitating determination of a presence of an unauthorized wireless network device includes means for receiving identification of the unauthorized wireless network device from the network identification service.

Example 58 may include the apparatus of example 57, wherein means for sending identifying information may include means for sending, for a wireless network device out of the one or more wireless network devices, a signal strength for the wireless network device.

Example 59 may include the apparatus of any one of examples 57-58, wherein means for sending identifying information may include means for sending, for a wireless network device out of the one or more wireless network devices, a MAC address for the wireless network device.

Example 60 may include the apparatus of any one of examples 57-59, wherein means for sending identifying information may include means for sending, for a wireless network device out of the one or more wireless network devices, an SSID for the wireless network device.

Example 61 may include the apparatus of any one of examples 57-60, wherein means for sending identifying information may include means for sending, for a wireless network device out of the one or more wireless network devices, traffic or connection data for the wireless network device.

Example 62 may include the apparatus of any one of examples 57-61, and may further include means for comparing identifying information for the one or more wireless network devices to a list including authorization information for a plurality of wireless network devices.

Example 63 may include the apparatus of any one of examples 57-62, and may further include means for analyzing traffic activity of the one or more wireless network devices to determine if the traffic activity is suspicious.

Example 64 may include the apparatus of any of examples 56-63, wherein means for issuing notification may include means for controlling one or more lights to issue a notification of identification of a presence of an unauthorized wireless network device through control of a color of the one or more lights.

Example 65 may include the apparatus of any of examples 56-64, wherein means for issuing notification may include means for controlling one or more lights to issue a notification of identification of a presence of an unauthorized wireless network device through control of a rate of blinking of the one or more lights.

Example 66 may include the apparatus of any of examples 56-64, wherein means for issuing notification may include means for controlling one or more lights to issue a notification of identification of a presence of an unauthorized wireless network device through control of a direction of the one or more lights.

Example 67 may include the apparatus of any of examples 56-63, wherein the apparatus further may include one or more light means and means for issuing notification may include means for controlling the one or more lights means to issue a notification of determination of a presence of an unauthorized wireless network device.

Example 68 may include the apparatus of example 67, wherein means for controlling the one or more lights may include means for controlling the one or more lights to emit a visible wavelength of light.

Example 69 may include the apparatus of example 67, wherein means for controlling the one or more lights may includes means for controlling the one or more lights to emit a non-visible wavelength of light.

Example 70 may include the apparatus of any of examples 56-69, wherein means for issuing notification may include means for controlling one or more speakers to produce audio to issue a notification of determination of a presence of the unauthorized wireless network device.

Example 71 may include a computer-implemented method for identifying unauthorized wireless network devices. The method may include: receiving, by an unauthorized network identification module of a computing system, identifying information for a one or more wireless network devices; based on the identifying information, identifying, by the unauthorized network identification module, an unauthorized wireless network device out of the one or more wireless network devices; and controlling, by a notification control module of the computing system, one or more remote notification devices to notify the identification of the unauthorized wireless network device.

Example 72 may include the method of example 71, wherein receiving identifying information may include receiving identifying information from the one or more remote notification devices.

Example 73 may include the method of any of examples 71 or 72, wherein the method further may include: determining, by a device location module of the computing system, a location of the unauthorized wireless network device; and controlling, by the notification control module, the one or more remote notification devices to notify the location of the unauthorized wireless network device.

Example 74 may include the method of example 73, wherein determining a location of the unauthorized wireless network device may include determining the location based on wireless network signal strength information received from the one or more remote notification devices.

Example 75 may include the method of any of examples 71-74, and may further include: determining, by the notification control module, a notification pattern for controlling the one or more remote notification devices; and controlling, by the notification control module, the one or more remote notification devices according to the pattern.

Example 76 may include the method of example 75, wherein determining a notification pattern may include determining a notification pattern controlling different remote notification devices to illuminate one or more lights using different light colors.

Example 77 may include the method of example 75, wherein determining a notification pattern may include determining a notification pattern controlling different remote notification devices to illuminate one or more lights using different light blinking rates.

Example 78 may include the method of example 75, wherein determining a notification pattern may include determining a notification pattern controlling different remote notification devices to output different audio notifications.

Example 79 may include the method of example 75, wherein determining a notification pattern may include determining a notification pattern controlling different remote notification devices according to their respective distances from the unauthorized wireless network device.

Example 80 may include one or more computer-readable media including instructions written thereon that, in response to execution by a computing system, cause the computing system to identify unauthorized wireless network devices. The instructions may cause the computing system to: receive identifying information for a one or more wireless network devices; based on the identifying information, identify an unauthorized wireless network device out of the one or more wireless network devices; and control one or more remote notification devices to notify the identification of the unauthorized wireless network device.

Example 81 may include the computer-readable media of example 80, wherein receive identifying information may include receive identifying information from the one or more remote notification devices.

Example 82 may include the computer-readable media of any of examples 80 or 81, wherein the instructions may be further to cause the computing system to: determine a location of the unauthorized wireless network device; and control the one or more remote notification devices to notify the location of the unauthorized wireless network device.

Example 83 may include the computer-readable media of example 82, wherein determine a location of the unauthorized wireless network device may include determine the location based on wireless network signal strength information received from the one or more remote notification devices.

Example 84 may include the computer-readable media of any of examples 80-83, wherein the instructions may be further to cause the computing system to: determine a notification pattern for controlling the one or more remote notification devices; and control the one or more remote notification devices according to the pattern.

Example 85 may include the computer-readable media of example 84, wherein determine a notification pattern may include determine a notification pattern controlling different remote notification devices to illuminate one or more lights using different light colors.

Example 86 may include the computer-readable media of example 84, wherein determine a notification pattern may include determine a notification pattern controlling different remote notification devices to illuminate one or more lights using different light blinking rates.

Example 87 may include the computer-readable media of example 84, wherein determine a notification pattern may include determine a notification pattern controlling different remote notification devices to output different audio notifications.

Example 88 may include the computer-readable media of example 84, wherein determine a notification pattern may include determine a notification pattern controlling different remote notification devices according to their respective distances from the unauthorized wireless network device.

Example 89 may include an apparatus for identifying unauthorized wireless network devices. The apparatus may include: means for receiving identifying information for a one or more wireless network devices; means for identifying, based on the identifying information an unauthorized wireless network device out of the one or more wireless network devices; and means for controlling one or more remote notification devices to notify the identification of the unauthorized wireless network device.

Example 90 may include the apparatus of example 89, wherein means for receiving identifying information may include means for receiving identifying information from the one or more remote notification devices.

Example 91 may include the apparatus of any of examples 89 or 90, and may further include means for determining a location of the unauthorized wireless network device; and means for controlling the one or more remote notification devices to notify the location of the unauthorized wireless network device.

Example 92 may include the apparatus of example 91, wherein means for determining a location of the unauthorized wireless network device may include means for determining the location based on wireless network signal strength information received from the one or more remote notification devices.

Example 93 may include the apparatus of any of examples 89-92, and may further include means for determining a notification pattern for controlling the one or more remote notification devices; and means for controlling the one or more remote notification devices according to the pattern.

Example 94 may include the apparatus of example 93, wherein means for determining a notification pattern may include means for determining a notification pattern controlling different remote notification devices to illuminate one or more lights using different light colors.

Example 95 may include the apparatus of example 93, wherein means for determining a notification pattern may include means for determining a notification pattern controlling different remote notification devices to illuminate one or more lights using different light blinking rates.

Example 96 may include the apparatus of example 93, wherein means for determining a notification pattern may include means for determining a notification pattern controlling different remote notification devices to output different audio notifications.

Examples 97 may include the apparatus of example 93, wherein means for determining a notification pattern may include means for determining a notification pattern controlling different remote notification devices according to their respective distances from the unauthorized wireless network device.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus comprising:
one or more wireless networking transceivers;
one or more computer processors coupled to the one or more wireless networking transceivers;
a network detection module to be operated by the one or more computer processors to:
receive signals for one or more wireless network devices via the wireless networking transceivers; and
based on the received signals for the one or more wireless network devices, facilitate determination of a presence of an unauthorized wireless network device; and
a notification module to be operated by the one or more computer processors to issue a notification of the determination of the presence of an unauthorized wireless network device.

2. The apparatus of claim 1, wherein:
the unauthorized wireless network identification module is further to be operated to send identifying information for the one or more wireless network devices to a remote network identification service; and
the unauthorized wireless network identification module is operated to facilitate determination of a presence of an unauthorized wireless network device through receipt of identification of the unauthorized wireless network device from the network identification service.

3. The apparatus of claim 2, wherein the unauthorized wireless network identification module is to send identifying information that includes, for a wireless network device out of the one or more wireless network devices, a signal strength for the wireless network device.

4. The apparatus of claim 2, wherein the unauthorized wireless network identification module is to send identifying information that includes, for a wireless network device out of the one or more wireless network devices, traffic or connection data for the wireless network device.

5. The apparatus of claim 1, wherein the notification module is operated to control one or more lights to issue a notification of identification of a presence of an unauthorized wireless network device through control of a color of the one or more lights.

6. The apparatus of any of claim 1, wherein the notification module is operated to control one or more lights to issue a notification of identification of a presence of an unauthorized wireless network device through control of a rate of blinking of the one or more lights.

7. The apparatus of any of claim 1, wherein the notification module is operated to control one or more lights to issue a notification of identification of a presence of an unauthorized wireless network device through control of a direction of the one or more lights.

8. The apparatus of any of claim 1, wherein:
the apparatus further comprises one or more lights; and
the notification module is operated to control the one or more lights to issue a notification of determination of a presence of an unauthorized wireless network device.

9. The apparatus of claim 1, wherein the notification module is to further control one or more speakers to produce audio to issue a notification of determination of a presence of the unauthorized wireless network device.

10. The apparatus of claim 9, further comprising the one or more speakers.

11. An apparatus comprising:
one or more computer processors;
an unauthorized network identification module to be operated by the one or more computer processors to:
receive identifying information for a one or more wireless network devices; and
based on the identifying information, identify an unauthorized wireless network device out of the one or more wireless network devices;
a notification control module to be operated by the one or more computer processors to control one or more remote notification devices to notify the identification of the unauthorized wireless network device.

12. The apparatus of claim 11, wherein the unauthorized network identification module is to receive identifying information from the one or more remote notification devices.

13. The apparatus of claim 12, wherein:
the apparatus further comprises a device location module to be operated by the one or more computer processors to determine a location of the unauthorized wireless network device; and
the notification control module is further to control the one or more remote notification devices to notify the location of the unauthorized wireless network device.

14. The apparatus of claim 13, wherein the device location module is to determine a location of the unauthorized wireless network device based on wireless network signal strength information received from the one or more remote notification devices.

15. The apparatus of claim 11, wherein the notification control module is further to:
determine a notification pattern for controlling the one or more remote notification devices; and
control the one or more remote notification devices according to the pattern.

16. The apparatus of claim 15, wherein notification control module is to determine a notification pattern controlling different remote notification devices to illuminate one or more lights using different light colors.

17. The apparatus of claim 15, wherein notification control module is to determine a notification pattern that controls different remote notification devices according to their respective distances from the unauthorized wireless network device.

18. One or more computer-readable media comprising instructions written thereon that, in response to execution by a computing system, cause the computing system to:
receive signals for one or more wireless network devices via one or more wireless networking transceivers;
based on the received signals for the one or more wireless network devices, facilitate determination of a presence of an unauthorized wireless network device; and
issue notification of the determination of the presence of an unauthorized wireless network device.

19. The computer-readable media of claim 18, wherein:
the instructions are further to cause the computing system to send identifying information for the one or more wireless network devices to a remote network identification service; and
facilitate determination of a presence of an unauthorized wireless network device comprises receive identification of the unauthorized wireless network device from the network identification service.

20. The computer-readable media of claim 19, wherein send identifying information comprises send, for a wireless network device out of the one or more wireless network devices, a signal strength for the wireless network device.

21. The computer-readable media of claim 18, wherein:
the computing system further comprises one or more lights; and
issue notification comprises control the one or more lights to issue a notification of determination of a presence of an unauthorized wireless network device.

22. A computer-implemented method comprising:
receiving, by a network detection module of a computing system, signals for one or more wireless network devices via one or more wireless networking transceivers;
based on the received signals for the one or more wireless network devices, facilitating, by the network detection module, determination of a presence of an unauthorized wireless network device; and
issuing, by a notification module of the computing system, notification of the determination of the presence of an unauthorized wireless network device.

23. The method of claim 22, wherein:
the method further comprises sending, by the unauthorized wireless network identification module, identifying information for the one or more wireless network devices to a remote network identification service; and
facilitating determination of a presence of an unauthorized wireless network device comprises receiving identification of the unauthorized wireless network device from the network identification service.

24. The method of claim 23, wherein sending identifying information comprises sending, for a wireless network device out of the one or more wireless network devices, a signal strength for the wireless network device.

25. The method of claim 22, wherein:
the computing system further comprises one or more lights; and
issuing notification comprises controlling the one or more lights to issue a notification of determination of a presence of an unauthorized wireless network device.
